(19) United States
(12) Patent Application Publication
(10) Pub. No.: US 2025/0158498 A1
(43) Pub. Date: May 15, 2025

(54) INDUCTION ROTOR ASSEMBLY

(71) Applicant: GM Global Technology Operations LLC, Detroit, MI (US)

(72) Inventors: John S. Agapiou, Rochester Hills, MI (US); Qigui Wang, Rochester Hills, MI (US)

(21) Appl. No.: 18/505,598

(22) Filed: Nov. 9, 2023

(51) Int. Cl. H02K 17/16; H02K 15/00

(52) U.S. Cl. CPC H02K 17/168; H02K 15/023

(57) ABSTRACT

An induction rotor assembly includes a laminated stack, conductor bars, a first end ring, and a second end ring. The laminated stack includes a body with a first end, an opposing second end, and an outer circumferential surface extending from the first end to the second end along a longitudinal axis. The conductor bars are disposed within grooves in the outer circumferential surface. Each conductor bar includes a first conductor end and a second conductor end extending beyond the ends of the laminated stack. The first conductor end and the second conductor end of each of the conductor bars includes a serrated surface having serrations. The first end ring and second end ring interlock with the serrated surface of the conductor ends. The conductor bars extend between the first end ring and the second end ring.

### INTRODUCTION

The present disclosure relates to induction rotor assemblies and more particularly systems and methods of making cast induction rotor assemblies having conductive bars.

An induction electric motor generally includes a stator and a rotor. The stator is stationary, while the rotor rotates and includes conductor bars arranged around a body of the rotor. The rotor contains a series of conductor bars arranged in a circular pattern around the rotor. When an electric current is applied to the stator, a magnetic field is created that interacts with the rotor and the conductor bars. This interaction causes the rotor to rotate, which in turn produces mechanical energy. As the rotor rotates, centrifugal force is exerted on the conductor bars within the rotor.

While current induction rotor assemblies achieve their intended purpose, there is a need for a system and method of making an induction rotor having conductor bars with a stronger mechanical connection to the body of the rotor and improved electrical connection between each of the conductor bars and the end rings of the rotor.

### SUMMARY

According to several aspects of the present disclosure, an induction rotor assembly having conductor bars with serrated surfaces is provided. The induction rotor assembly includes a laminated stack, a plurality of conductor bars, a first end ring, and a second end ring. The laminated stack includes a body with a first end and an opposing second end arranged along a longitudinal axis. Additionally, the body has an outer circumferential surface that extends from the first end to the second end along the longitudinal axis. The outer circumferential surface has a plurality of grooves extending from the first end through the second end. Each of the plurality of conductor bars is disposed within each of the grooves. Each of the plurality of conductor bars includes a first conductor end extending axially beyond the first end of the laminated stack, and the first conductor end of each of the plurality of conductor bars includes a serrated surface having a plurality of serrations. Each of the plurality of conductor bars includes a second conductor end extending axially beyond the second end of the laminated stack, and the second conductor end includes a serrated surface having a plurality of serrations. The first end ring has a plurality of serrated surfaces opposing and mating with the serrated surface of each first conductor end to interlock each of the plurality of conductor bars to the first end ring. The second end ring has a plurality of serrated surfaces opposing and mating with the serrated surface of each second conductor end to interlock each of the plurality of conductor bars to the second end ring. The plurality of conductor bars extends between the first end ring and the second end ring.

In accordance with another aspect of the disclosure, the induction rotor assembly includes a plurality of laminated steel sheets.

In accordance with another aspect of the disclosure, the induction rotor assembly includes a plurality of conductor bars s formed from at least one of copper or aluminum.

In accordance with another aspect of the disclosure, the induction rotor assembly includes conductor bars with an interlock feature disposed as part of at least one of the first conductor end or the second conductor end. The interlock feature provides mechanical bonding to at least one of the first end ring or the second end ring.

In accordance with another aspect of the disclosure, the induction rotor assembly includes a first end ring and a second end ring that are cast in place over the first conductor end and the second conductor end, respectively, of each of the plurality of conductor bars.

In accordance with another aspect of the disclosure, the induction rotor assembly includes a first end ring and a second end ring that include and are formed from aluminum.

In accordance with another aspect of the disclosure, the induction rotor assembly includes serrations on a serrated surface having a depth of between 0.1 and 0.5 millimeters.

In accordance with another aspect of the disclosure, the induction rotor assembly includes serrations on a serrated surface having a pitch between 0.5 and 1.5 millimeters.

In accordance with another aspect of the disclosure, the induction rotor assembly includes serrations on a serrated surface that extend parallel to the longitudinal axis.

In accordance with another aspect of the disclosure, the induction rotor assembly includes serrations that extend a full longitudinal length of each of the plurality of conductor bars. At least two surfaces of each of the plurality of conductor bars include the serrated surface.

In accordance with another aspect of the disclosure, the induction rotor assembly includes serrations on the serrated surface that extend perpendicular to the longitudinal axis.

In accordance with another aspect of the disclosure, the induction rotor assembly has serrations with a series of repeating half circle indentations.

In accordance with another aspect of the disclosure, a vehicle motor includes a stator and an induction rotor assembly. The induction rotor assembly includes a laminated stack, a plurality of conductor bars, a first end ring, and a second end ring. The laminated stack includes a body with a first end and an opposing second end arranged along a longitudinal axis. Additionally, the body has an outer circumferential surface that extends from the first end to the second end along the longitudinal axis. The outer circumferential surface has a plurality of grooves extending from the first end to the second end. Each of the plurality of conductor bars is disposed within each of the grooves. Each of the plurality of conductor bars includes a first conductor end extending axially beyond the first end of the laminated stack and a second conductor end extending axially beyond the second end of the laminated stack. The first conductor end and the second conductor end of each of the plurality of conductor bars includes a serrated surface having a plurality of serrations. The first end ring has a plurality of serrated surfaces opposing and mating with the serrated surface of each first conductor end to interlock each of the plurality of conductor bars to the first end ring. The second end ring has a plurality of serrated surfaces opposing and mating with the serrated surface of each second conductor end to interlock each of the plurality of conductor bars to the second end ring. The conductor bars extend between the first end ring and the second end ring.

In accordance with another aspect of the disclosure, the vehicle motor has an induction rotor assembly with a plurality of conductor bars formed from copper or aluminum.

In accordance with another aspect of the disclosure, the vehicle motor has an induction rotor assembly with an interlock feature on at least one of the first conductor end or the second conductor end. The interlock feature provides mechanical bonding to at least one of the first end ring or the second end ring.

In accordance with another aspect of the disclosure, a method of manufacturing an induction rotor assembly is disclosed. The method includes forming conductor bars to define a serrated surface having serrations on a first conductor end of each of the plurality of conductor bars. The method includes laminating a plurality of steel sheets to form a laminated stack. The laminated stack includes a first end and an opposing second end axially spaced along a longitudinal axis. A plurality of grooves are disposed on an outer circumferential surface of the laminated stack. The plurality of grooves extend from the first end to the second end of the laminated stack. Additionally, the method includes positioning a conductor bar in each of the grooves such that the first conductor end extends beyond the first end of the laminated stack. Further, the method includes casting a first end ring in place around each first conductor end and the serrated surface of the first conductor end and casting a second end ring in place around each second conductor end and the serrated surface of the second conductor end of each of the conductor bars. The first end ring at least partially surrounds and electrically connects to the first conductor end and the second conductor end of each of the plurality of conductor bars. The serrated surface provides mechanical bonding between the first end ring and the plurality of conductor bars.

In accordance with another aspect of the disclosure, the method includes placing the laminated stack with the plurality of conductor bars positioned therein into a form. Molten material is then injected into the form and around the serrations on the serrated surface of the first conductor end of each of the plurality of conductor bars.

In accordance with another aspect of the disclosure, the method includes positioning at least one conductor bar having an interlock feature disposed as part of at least one of the first conductor end or the second conductor end. The interlock feature provides mechanical bonding to at least one of the first end ring or the second end ring.

In accordance with another aspect of the disclosure, the method includes positioning at least one conductor bar having a plurality of serrations extending parallel to the longitudinal axis.

In accordance with another aspect of the disclosure, the method includes the first end ring having a plurality of serrated surfaces opposing and mating with the serrated surface of each first conductor end. The method also includes the second end ring having a plurality of serrated surfaces opposing and mating with the serrated surface of each second conductor end.

### BRIEF DESCRIPTION OF THE DRAWINGS

The drawings described herein are for illustration purposes only and are not intended to limit the scope of the present disclosure in any way.

FIG. 1 is a perspective view illustrating a vehicle having an electric motor with an induction rotor assembly, in accordance with the present disclosure.

FIG. 2 is a schematic exploded view illustrating the induction rotor assembly shown in FIG. 1, where the induction rotor assembly includes a plurality of conductor bars, in accordance with the present disclosure.

FIG. 3A is a side perspective view illustrating a conductor bar with a first conductor end having a serrated surface with serrations oriented perpendicular to a length of the conductor bar, in accordance with the present disclosure.

FIG. 3B is a side perspective view illustrating an alternate conductor bar with a first conductor end having a serrated surface with serrations oriented parallel to a length of the conductor bar, in accordance with the present disclosure.

FIG. 3C is a magnified cross section view along lines 3C-3C shown in FIG. 3B depicting serrations of the serrated surface, in accordance with the present disclosure.

FIG. 4 is a cross section top view along lines 4-4 shown in FIG. 3B depicting a conductor bar having a first serrated surface, a second serrated surface opposite from the first serrated surface, and a fin, in accordance with the present disclosure.

FIG. 5 is a partial cross-sectional view illustrating an alternate conductor bar having a first serrated surface and a second serrated surface with serrations in a jagged configuration, in accordance with the present disclosure.

FIG. 6 is a partial perspective side view of the induction rotor assembly shown in FIG. 2 depicting a cut away view of the first end ring cast in place around a first conductor end of the conductor bar, and the first conductor end has a serrated surface with serrations, in accordance with the present disclosure.

FIG. 7 is a flowchart illustrating a method of manufacturing the induction rotor assembly having conductor bars with a serrated surface shown in FIG. 2, in accordance with the present disclosure.

### DETAILED DESCRIPTION

The following description is merely exemplary in nature and is not intended to limit the present disclosure, application, or uses.

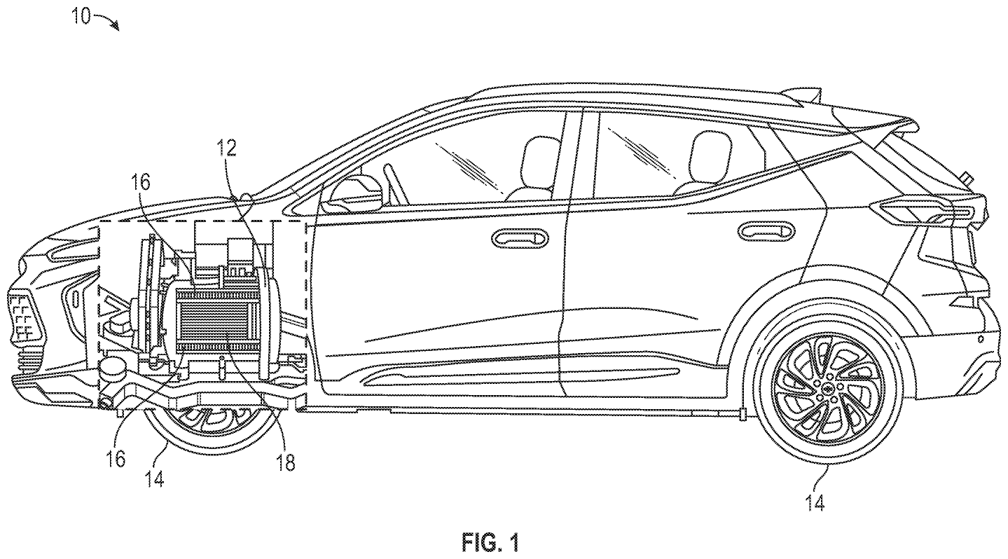

Referring to FIG. 1, a vehicle 10 having a vehicle motor 12 or inverter is shown, according to the principles of the present disclosure. The vehicle motor 12 provides motive power to the vehicle 10 and receives electrical power from at least one battery (not shown). The vehicle motor 12 is illustrated with an exemplary vehicle 10, and the vehicle 10 is an electric vehicle or hybrid vehicle having wheels 14 driven by the vehicle motor 12. The vehicle motor 12 includes an induction electric motor. While the vehicle 10 is illustrated as a passenger road vehicle, it should be appreciated that the vehicle motor 12 may be used with various other types of vehicles. For example, the vehicle motor 12 may be used in nautical vehicles, for example boats, or aeronautical vehicles, for example drones or passenger airplanes. Moreover, the vehicle motor 12 may be used as a stationary power source separate and independent from a vehicle.

FIG. 1 is a cut away view of the vehicle motor 12 illustrating a stator 16 and an induction rotor assembly 18. The stator 16 is a stationary portion of a rotary system within the vehicle motor 12 and is formed from steel. Electricity is provided to the stator 16 and is converted to a rotating magnetic field. The induction rotor assembly 18 rotates due to the rotating magnetic field and provides torque to the vehicle 10 for motive power.

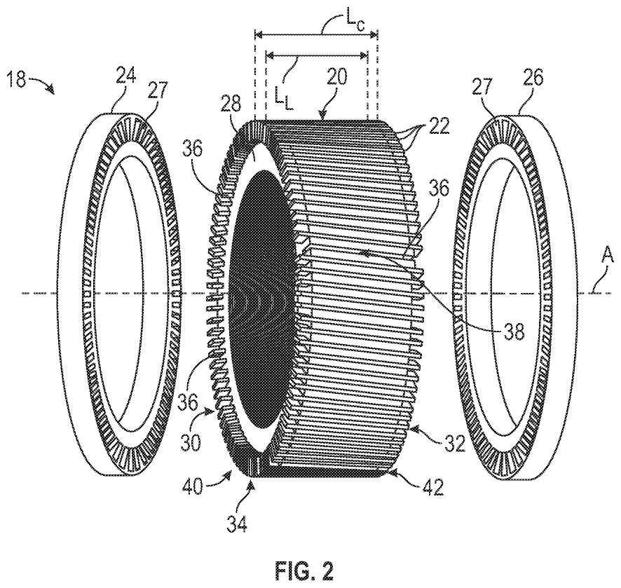

FIG. 2 illustrates a schematic exploded perspective view of the induction rotor assembly 18. The induction rotor assembly 18 includes a laminated stack 20, a plurality of conductor bars 22, a first end ring 24, and a second end ring 26.

The laminated stack 20 includes a body 28 having a first end 30 and an opposing second end 32 to define a longitudinal axis A. The body 28 is formed from a plurality of laminated steel sheets stacked in an axial direction. In one example, the body 28 is steel or steel alloy. The body 28 has an outer circumferential surface 34 extending from the first end 30 to the second end 32 coaxial with the longitudinal axis A. As shown in FIG. 2, the outer circumferential surface 34 has a plurality of longitudinal walls 36 defining a plurality of open longitudinal grooves 38 formed therethrough from the first end 30 to the second end 32. The longitudinal grooves 38 may be slightly skewed relative to longitudinal axis A along a length LL of the laminated stack 20. Additionally, the longitudinal grooves 38 may be parallel to longitudinal axis A.

Still referring to FIG. 2, each of the plurality of conductor bars 22 is disposed within each of the longitudinal grooves 38. FIG. 2 illustrates one conductor bar 22 removed to show one longitudinal groove 38 defined by the longitudinal walls 36 for convenience. The conductor bars 22 carry induced current in the induction rotor assembly 18, which interacts with the magnetic field produced by the stator 16 and produces torque. Each of the plurality of conductor bars 22 has a first conductor end 40. The first conductor end 40 extends axially beyond the first end 30 of the laminated stack 20. Each of the plurality of conductor bars 22 also has a second conductor end 42. The second conductor end 42 extends axially beyond the second end 32 of the laminated stack 20. Each of the conductor bars 22 has a conductor length L_{C} extending parallel to the longitudinal axis A. The conductor bars 22 may be manufactured from aluminum or copper.

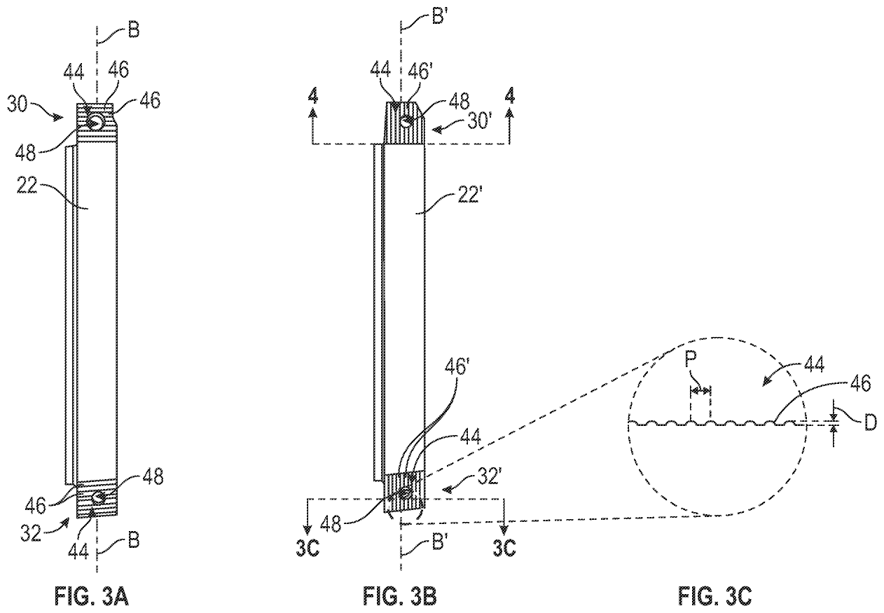

Referring now to FIG. 3A a side view of the conductor bars 22 is illustrated. The first end 30 and the second end 32 of the conductor bars 22 are shown with a serrated surface 44 at the first conductor end 40 and the second conductor end 42 having a plurality of serrations 46. The serrations 46 include parallel alternating valleys and ridges and/or grooves that extend along the serrated surface 44. The spaced grooves of serrations 46 extend perpendicular to the longitudinal axis B of the conductor bars 22. Optionally, the first end 30 and the second end 32 may include an interlock feature 48. The interlock feature 48 includes a hole or other opening in the first end 30 and/or the second end 32 punched into and extending through the conductor bar 22.

FIG. 3B is an alternate conductor bar 22′ having serrations 46′ that extend parallel to the longitudinal axis B′. It will be appreciated that the serrations 46, 46′ may be in other configurations and may be located on each conductor bar 22, 22′ at locations other than or in addition to the first end 30, 30′ and/or the second end 32, 32′. For example, the serrations 46, 46′ may be disposed at the first end 30, 30′, the second end 32, 32′, and may also extend an entire length L_{C} of each conductor bar 22, 22′ parallel with the longitudinal axis B, B′. In another example, the serrations 46 may be oriented on the serrated surface 44 at an angle (e.g., 45°) from the longitudinal axis B, B′.

FIG. 3C is a magnified cross section view of the serrated surface 44 and serrations 46 shown along lines 3C-3C in FIG. 3B. The serrations 46 are grooves spaced apart from each other. In this specific example, the serrations 46 have a pitch P of one millimeter and a groove depth D of 0.25 millimeters. It will be appreciated that the serrations 46 may have a variety of pitches (e.g., between 0.5 and 1.5 millimeters) and a variety of depths (e.g., between 0.1 and 0.5 millimeters).

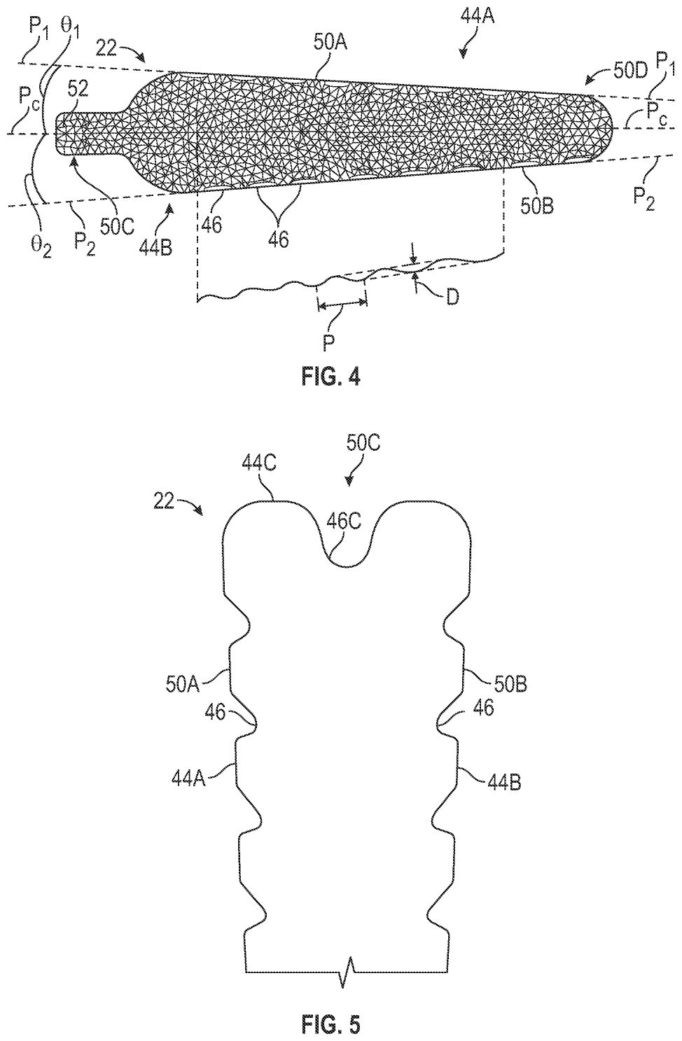

Referring to FIG. 4, a top cross section view of the conductor bar 22′ is shown along lines 4-4 shown in FIG. 3B. The conductor bar 22 includes a first side 50A having a first serrated surface 44A, a second side 50B having a second serrated surface 44B, a third side 50C, a fourth side 50D opposite the third side 50C, and a fin 52. The first side 50A is opposite the second side 50B. As shown in FIG. 4, a plane P₁ of the first side 50A may be non-parallel to and at an angle θ₁ (e.g., 5°, 10°, 15°, and so forth) from a center plane Pc extending through the conductor bar 22 from the third side 50C to the fourth side 50D. A plane P₂ of the second side 50B may be non-parallel to and at an angle θ₂ (e.g., 5°, 10°, 15°, and so forth) from the center plane Pc. The non-parallel first side 50A and second side 50B allow a larger number of the conductor bars 22 to be circumferentially arranged around the body 28 of the laminated stack 20 in the longitudinal grooves 38 as compared to conductor bars having parallel sides. However, it is within the scope of the present disclosure to have conductor bars with the first side 50A parallel to the second side 50B. The fin 52 is disposed on a third side 50C of the conductor bar 22 and extends beyond the outer circumferential surface 34 of the body 28 of the laminated stack 20. Additionally, FIG. 4 shows the second serrated surface 44B having serrations 46 with a pitch P of between 1 and 1.2 millimeters and a depth of between 0.25 and 0.3 millimeters.

Referring to FIG. 5, a partial top cross sectional view illustrates the first side 50A and the second side 50B of conductor bar 22 having a first serrated surface 44A and a second serrated surface 44B with serrations 46 that are jagged. The jagged serrations 46 include a jagged or uneven profile, for example a sawtooth. In FIG. 5, the jagged serrations 46 include offset half circles, although the jagged serrations 46 may include other configurations, for example a series of protruding points or a toothed surface. In some instances, the conductor bar 22 may have a third side 50C having a third serrated surface 44C that is perpendicular to the at least one of the first serrated surface 44A or the second serrated surface 44B. The third serrated surface 44C includes at least one serration 46C.

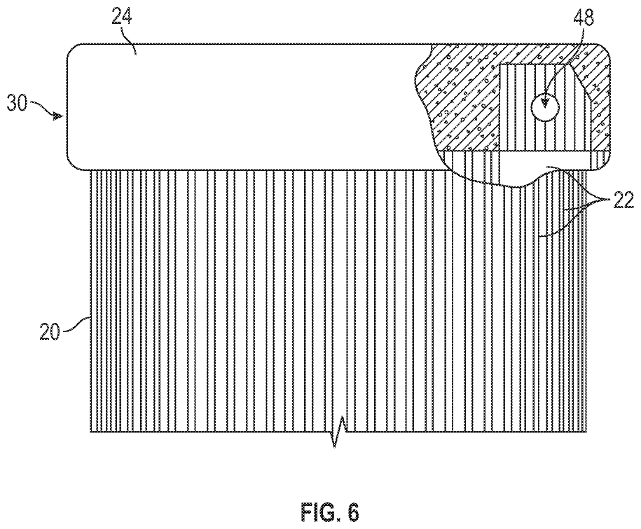

Referring to FIG. 6 and again to FIG. 2, the first end ring 24 abuts and is fixed to each of the first conductor ends 40 of each of the plurality of conductor bars 22 at the first end 30 of the laminated stack 20, and the second end ring 26 abuts and is fixed to each of the second conductor ends 42 of each of the plurality of conductor bars 22 at the second end 32 of the laminated stack 20. The first end ring 24 at least partially surrounds and electrically couples the first end 30 to the conductor bars 22. The second end ring 26 at least partially surrounds and electrically couples the second end 32 to the conductor bars 22. The first end ring 24 and the second end ring 26 are preferably cast in place from aluminum or a cast aluminum alloy. However, it should be appreciated that the first end ring 24 and the second end ring 26 may be cast in place from other conductive materials.

The cast in place first end ring 24 includes a plurality of serrated surfaces 27 opposing and mating with the serrated surface 44 of each first conductor end 40 to interlock each of the plurality of conductor bars 22 to the first end ring 24. Similarly, the cast in place second end ring 26 includes a plurality of serrated surfaces 27 opposing and mating with the serrated surface 44 of each second conductor end 42 to interlock each of the plurality of conductor bars 22 to the second end ring 26. When the first end 30 and/or the second end 32 include an interlock feature 48, the cast in place first end ring 24 and/or the second end ring 26 also mechanically interlocks with the interlock feature 48.

The serrations 46 of each serrated surface 44 allow the material of the cast in place first end ring 24 and the second end ring 26 to flow into the grooves 38 and mechanically interlock with the serrated surface 44, thereby improving the mechanical and electrical bond between the conductor bars 22 and the first end ring 24 or the second end ring 26. As the material flows into the grooves 38, a plurality of serrated surfaces are formed in the first end ring 24 and the second end ring 26 that interlock with the serrated surfaces 44 on the first conductor end 40 and the second conductor end 42, respectively, to interlock each of the plurality of conductor bars 22 to the first end ring 24 and the second end ring 26. Additionally, the serrations 46 improve wetting and intermetallic compound formation between each conductor bar 22 and the first end ring 24 or the second end ring 26. Further, the serrations 46 increase surface reaction area between the conductor bar 22 and the first end ring 24 or the second end ring 26 during the casting process.

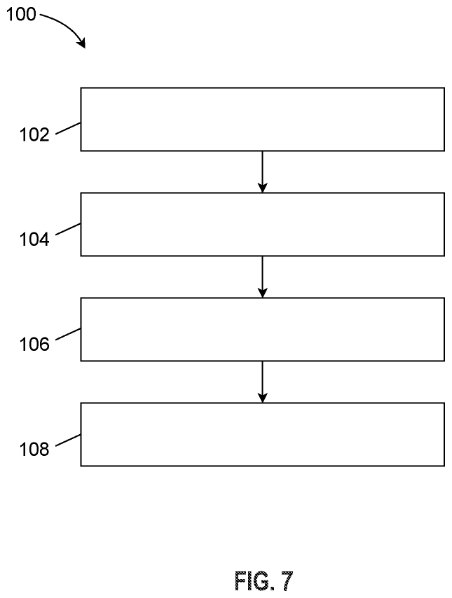

Referring now to FIG. 7, a flowchart illustrating a method 100 for manufacturing an induction rotor assembly 18 is presented, in accordance with the present disclosure. The method starts at block 102 where conductor bars 22 are formed. The conductor bars 22 are formed to include a conductor length L_{C} longer than the laminated stack length LL so that the first conductor end 40 and the second conductor end 42 extend outward beyond the first end 30 and the second end 32 of the laminated stack 20, respectively. The conductor bars 22 are also formed to define the serrated surface 44 having serrations 46 on the first conductor end 40 and the second conductor end 42. The serrations 46 are formed in various ways, including using a die to generate a wavy profile on the first conductor end 40 and the second conductor end 42, using a water jet cutting process, or a mechanical polishing process. The conductor bars 22, and particularly the serrations 46, are pre-formed prior to casting the first end ring 24 and the second end ring 26 over the first conductor end 40 and the second conductor end 42 of each conductor bar 22.

The method then moves to block 104. Block 104 depicts laminating a plurality of steel sheets to define the laminated stack 20. The laminated stack 20 includes the first end 30 and the second end 32. The second end 32 is axially spaced from the first end 30 along the longitudinal axis A. The steel sheets are laminated together so that slots in each of the steel sheets cooperate to define the grooves 38 extending along the longitudinal axis A. The grooves 38 are angularly spaced about and equidistant from the longitudinal axis A.

Next, block 106 depicts positioning one of the conductor bars 22 in each of the longitudinal grooves 38. The conductor bars 22 are positioned so that the first conductor end 40 and the second conductor end 42 of each of the plurality of conductor bars 22 extend axially outward beyond the first end 30 and the second end 32 of the laminated stack 20, respectively.

Then, block 108 depicts casting the first end ring 24 in place around the first conductor end 40. The method 100 may also include casting the second end ring 26 in place around the second conductor end 42. Casting the first end ring 24 and the second end ring 26 in place can include placing the laminated stack 20, having the plurality of conductor bars 22 positioned therein, into a form. The form defines the first end ring 24 and/or the second end ring 26 and can be any suitable shape and size for casting the first end ring 24 and/or the second end ring 26. The first end ring 24 is cast in place around the serrated surface 44 and the serrations of the first conductor end 40 on each of the conductor bars 22. The first end ring 24 is cast to at least partially surround and electrically connect the first conductor end 40 of each of the plurality of conductor bars 22 with the first end ring 24. Additionally, the second end ring 26 is cast in place around the serrated surface 44 and the serrations of the second conductor end 42 on each of the conductor bars 22. The second end ring 26 is cast to at least partially surround and electrically connect the second conductor end 42 of each of the plurality of conductor bars 22 with the second end ring 26. Further, casting the first end ring 24 and the second end ring 26 includes injecting molten material into the form and around the serrations 46 in the serrated surface 44 of the first conductor end 40 and the second conductor end 42 of each conductor bar 22. The first end ring 24 and the second end ring 26 is preferably cast from aluminum or an aluminum alloy. It will be appreciated that the first end ring 24 and the second end ring 26 may be cast using some other conductive material. Casting the first end ring 24 and/or the second end ring 26 includes flowing the molten material in and around the serrations 46 so that the molten material and the mechanically interlocks with the serrated surface 44 of the first conductor end 40 and the serrated surface 44 of the second conductor end 42 of each conductor bar 22 upon solidification. Casting processes that may be used to cast the first end ring 24 and the second end ring 26 include a high pressure die casting process, a low pressure die casting process, a sand-casting process, or a squeeze casting process.

Casting the first end ring 24 and the second end ring 26 may further include compressing the molten material as the molten material solidifies. Compressing the molten material as the molten material solidifies during the casting process reduces porosity on the finished cast in place product and improves mechanical properties of the finished product.

The method 100 may further include vibrating each of the conductor bars 22 at an ultrasonic frequency for a pre-defined period of time during solidification of the molten material of the cast in place first end ring 24 and/or the second end ring 26. Preferably, the ultrasonic frequency is 20 kHz or greater. The conductor bars 22 may be vibrated for a time less than 20 seconds. Vibrating the conductor bars 22 during solidification of the molten material during the casting process can break up aluminum oxides disposed on the outer surface of the first conductor end 40 and/or the second conductor end 42 of the conductor bars 22. Vibrating the conductor bars 22 also improves wetting between the molten material and the conductor bars 22.

The present disclosure has many advantages and benefits over prior art induction rotor assemblies. For example, forming serrations 46 on a serrated surface 44 of the first conductor end 40 and/or the second conductor end 42 and casting in place the first end ring 24 and the second end ring 26 around each first conductor end 40 and/or second conductor end 42 facilitates an improved mechanical joining and structure integrity of the metallurgical joint between the conductor bars 22 and the first end ring 24 and the second end ring 26. Additionally, including the serrations 46 improves wetting, removes melt front surface oxides, and improves intermetallic compounds (IMC) formation and increases surface reaction area between the conductor bars 22 and the first end ring 24 and second end ring 26. Utilizing the conductor bars 22 with the serrated surfaces 44 having serrations 46 instead of conventional conductor bars increases mechanical and electrical connection and integrity of the induction rotor assembly while providing a lightweight induction rotor assembly.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. An induction rotor assembly, comprising:
a laminated stack including a body having a first end and an opposing second end arranged along a longitudinal axis, wherein the body has an outer circumferential surface extending from the first end to the second end along the longitudinal axis, wherein the outer circumferential surface has a plurality of grooves extending from the first end to the second end;
a plurality of conductor bars, wherein each of the plurality of conductor bars is disposed within each of the grooves, and wherein each of the plurality of conductor bars includes a first conductor end extending axially beyond the first end of the laminated stack and a second conductor end extending axially beyond the second end of the laminated stack, and wherein the first conductor end and the second conductor end of each of the plurality of conductor bars includes a serrated surface having a plurality of serrations;
a first end ring having a plurality of serrated surfaces opposing and mating with the serrated surface of each first conductor end to interlock each of the plurality of conductor bars to the first end ring; and
a second end ring having a plurality of serrated surfaces opposing and mating with the serrated surface of each second conductor end to interlock each of the plurality of conductor bars to the second end ring, and wherein the plurality of conductor bars extend between the first end ring and the second end ring.

2. The induction rotor assembly of claim 1, wherein the body includes a plurality of laminated steel sheets.

3. The induction rotor assembly of claim 1, wherein the plurality of conductor bars is formed from at least one of copper or aluminum.

4. The induction rotor assembly of claim 1, wherein at least one of the plurality of conductor bars includes an interlock feature disposed as part of at least one of the first conductor end or a second conductor end, wherein the interlock feature is configured to provide mechanical bonding to at least one of the first end ring or the second end ring.

5. The induction rotor assembly of claim 1, wherein the first end ring and the second end ring are each cast in place over the first conductor end and a second conductor end, respectively, of each of the plurality of conductor bars.

6. The induction rotor assembly of claim 5, wherein the first end ring and the second end ring include and are formed from aluminum.

7. The induction rotor assembly of claim 1, wherein each serration of the serrated surface has a depth of between 0.1 and 0.5 millimeters.

8. The induction rotor assembly of claim 1, wherein serrations of the serrated surface have a pitch between 0.5 and 1.5 millimeters.

9. The induction rotor assembly of claim 1, wherein the plurality of serrations on the serrated surface extend parallel to the longitudinal axis.

10. The induction rotor assembly of claim 9, wherein the plurality of serrations extend a full longitudinal length of each of the plurality of conductor bars, and at least two surfaces of each of the plurality of conductor bars include the serrated surface.

11. The induction rotor assembly of claim 1, wherein the plurality of serrations on the serrated surface extend perpendicular to the longitudinal axis.

12. The induction rotor assembly of claim 1, wherein each of the plurality of serrations includes a series of repeating half circle indentations.

13. A vehicle motor, comprising:
a stator; and
an induction rotor assembly configured to rotate due to a rotating magnetic field created by the stator, wherein the induction rotor assembly includes
a laminated stack including a body having a first end and an opposing second end arranged along a longitudinal axis, the body having an outer circumferential surface extending from the first end to the second end along the longitudinal axis, the outer circumferential surface having a plurality of grooves extending from the first end to the second end;
a plurality of conductor bars, wherein each of the plurality of conductor bars is disposed within each of the grooves, and wherein each of the plurality of conductor bars includes a first conductor end extending axially beyond the first end of the laminated stack and a second conductor end extending axially beyond the second end of the laminated stack, wherein the first conductor end and the second conductor end of each of the plurality of conductor bars includes a serrated surface having a plurality of serrations;
a first end ring having a plurality of serrated surfaces opposing and mating with the serrated surface of each first conductor end to interlock each of the plurality of conductor bars to the first end ring; and
a second end ring having a plurality of serrated surfaces opposing and mating with the serrated surface of each second conductor end to interlock each of the plurality of conductor bars to the second end ring, and wherein the plurality of conductor bars extends between the first end ring and the second end ring.

14. The induction rotor assembly of claim 13, wherein the plurality of conductor bars is formed from at least one of copper or aluminum.

15. The induction rotor assembly of claim 13, wherein at least one of the plurality of conductor bars includes an interlock feature disposed as part of at least one of the first conductor end or the second conductor end, wherein the interlock feature is configured to provide mechanical bonding to at least one of the first end ring or the second end ring.

16. A method of manufacturing an induction rotor assembly, comprising:
forming a plurality of conductor bars to define a serrated surface having serrations on a first conductor end of each of the plurality of conductor bars;
laminating a plurality of steel sheets to form a laminated stack having a first end and an opposing second end axially spaced along a longitudinal axis, wherein a plurality of grooves are disposed on an outer circumferential surface of the laminated stack and extend from the first end to the second end;
positioning one of the plurality of conductor bars in each of the grooves such that the first conductor end extends axially beyond the first end of the laminated stack; and
casting a first end ring in place around each first conductor end and the serrated surface of the first conductor end of each of the plurality of conductor bars and a second end ring in place around each second conductor end and the serrated surface of the second conductor end of each of the plurality of conductor bars to at least partially surround and electrically connect the first conductor end and the second conductor end of each of the plurality of conductor bars, wherein the serrated surface is configured to provide mechanical bonding between the first end ring and the plurality of conductor bars.

17. The method of claim 16, wherein casting the first end ring includes placing the laminated stack with the plurality of conductor bars positioned therein into a form and injecting molten material into the form and around the serrations on the serrated surface of the first conductor end of each of the plurality of conductor bars.

18. The method of claim 16, wherein at least one of the plurality of conductor bars includes an interlock feature disposed as part of at least one of the first conductor end or a second conductor end, wherein the interlock feature is configured to provide mechanical bonding to at least one of the first end ring or the second end ring.

19. The method of claim 16, wherein the serrations on the serrated surface extend parallel to the longitudinal axis.

20. The method of claim 16, wherein the first end ring includes a plurality of serrated surfaces opposing and mating with the serrated surface of each first conductor end, and the second end ring includes a plurality of serrated surfaces opposing and mating with the serrated surface of each second conductor end.
